(19) United States
(12) Patent Application Publication
(10) Pub. No.: US 2011/0172952 A1
(43) Pub. Date: Jul. 14, 2011

(54) Apparatus and Method for Measuring Position and/or Motion Using Surface Micro-Structure

(76) Inventors: Upendra UMMETHALA, Cupertino, CA (US); Noah BAREKET, Saratoga, CA (US); Christopher BEVIS, Los Gatos, CA (US)

(21) Appl. No.: 12/573,786

(22) Filed: Oct. 5, 2009

(51) Int. Cl. G06F 15/00; G01B 11/14

(52) U.S. Cl. 702/149; 356/614; 702/150

(57) ABSTRACT

One embodiment relates to a method in which a measuring apparatus is used to collect a first set of wave form data which depends on micro-structure of a moving surface. A correspondence is identified between the first set of wave form data and actual position data. Calibrated wave form data is stored which indicates said correspondence between the first set of wave form data and actual position data. In addition, the measuring apparatus may be used to collect a second set of wave form data which depends on micro-structure of the moving surface, a cross-correlation may be computed between the second set of wave form data and the calibrated wave form data. Another embodiment relates to an apparatus for measuring position and/or motion using surface micro-structure of a moving surface. Another embodiment relates to method for measuring motion using surface micro-structure. Other embodiments and features are also disclosed.

### GOVERNMENT LICENSE RIGHTS

The U.S. Government has a paid-up license in this invention and the right in limited circumstances to require the patent owner to license others on reasonable terms as provided for by the terms of Contract No. HR001-06-03-0008 awarded by the Defense Advanced Research Projects Agency.

### BACKGROUND

1. Technical Field

The present application relates generally to motion measurement and/or control. The technology disclosed herein may be used, for example, with semiconductor manufacturing apparatus and processes. The technology disclosed herein may also be used with other apparatus and processes in which it is useful to measure and/or control the motion of a moving surface.

2. Description of the Background Art

Precision motion control systems generally rely on a variety of metrology tools sensing and measuring the system motion and providing the required feedback to the control system. These metrology tools include position encoders and laser interferometers.

Of particular interest, optical encoders may be used for motion measurement and control. In such encoders, an optical source is typically arranged to illuminate a graduated surface which is marked (graduated) with areas of high and low reflectivity, and a sensor detects a time-dependent signal generated by the reflection of the optical signal from the moving graduated surface. However, optical encoders are limited in size when nanometer level accuracy is required. It is especially problematic to make optical rotary encoders for large diameters with nanometer level accuracy. This limits the encoder resolution and ultimately the measurement accuracy.

### BRIEF DESCRIPTION OF THE DRAWINGS

FIG. 1 is a schematic diagram showing basic components of an optical apparatus which may be utilized to obtain a reflected light signal relating to surface microstructure in accordance with an embodiment of the invention.

FIG. 2 is a schematic diagram of a specific implementation of an optical apparatus which may be utilized to obtain a reflected light signal relating to surface microstructure in accordance with an embodiment of the invention.

FIG. 3 is a graph showing an example reflected light signal which was obtained by focusing a laser beam onto a moving metal surface in accordance with an embodiment of the invention.

FIG. 4 is a flow chart showing a method of calibration and a method of position measurement and control in accordance with an embodiment of the invention.

FIG. 5 is a graph showing a range of wave form data from multiple scans of a same section of a moving surface in accordance with an embodiment of the invention.

FIG. 6 is a graph with a “zoomed in” view showing a shorter range of wave form data from two scans of a same section of a moving surface in accordance with an embodiment of the invention.

FIG. 7 shows an output of a correlation filter in accordance with an embodiment of the invention.

FIG. 8 shows an apparatus for measuring a speed of a moving surface using surface micro-structure in accordance with an embodiment of the invention.

FIG. 9 is a schematic diagram of an example primary instrument with which an embodiment of the invention may be utilized.

FIG. 10 is a top view diagram of a rotatable platter configured to hold six wafers in accordance with an embodiment of the invention.

FIG. 11 is a top view diagram showing a swath path arcing across an array of die areas on a semiconductor wafer in accordance with an embodiment of the invention.

### SUMMARY

One embodiment relates to a method in which a measuring apparatus is used to collect a first set of wave form data which depends on micro-structure of a moving surface. A correspondence is identified between the first set of wave form data and actual position data. Calibrated wave form data is stored which indicates said correspondence between the first set of wave form data and actual position data. In addition, the measuring apparatus may be used to collect a second set of wave form data which depends on micro-structure of the moving surface, a cross-correlation may be computed between the second set of wave form data and the calibrated wave form data.

Another embodiment relates to an apparatus for measuring position and/or motion using surface micro-structure of a moving surface. The apparatus includes at least a detector configured to generate an output signal which varies in correspondence with the surface micro-structure, and a correlation filter configured to receive the output signal, apply cross-correlation between the output signal and a calibrated signal, and generate a measured position signal.

Another embodiment relates to method for measuring motion using surface micro-structure. A first apparatus is used to collect a first wave form from a moving surface, and a second apparatus, which is separated from the first apparatus by a fixed distance, is used to collect a second wave form from the moving surface. The first and second wave forms depend on micro-structure of the moving surface. A time advance is determined which indicates a time period during which a point on the moving surface moved between the first apparatus and the second apparatus, and a speed is computed based on dividing the fixed distance by the time advance.

Other embodiments and features are also disclosed.

### DETAILED DESCRIPTION

### Motion Measurement and Control Using Surface Microstructure

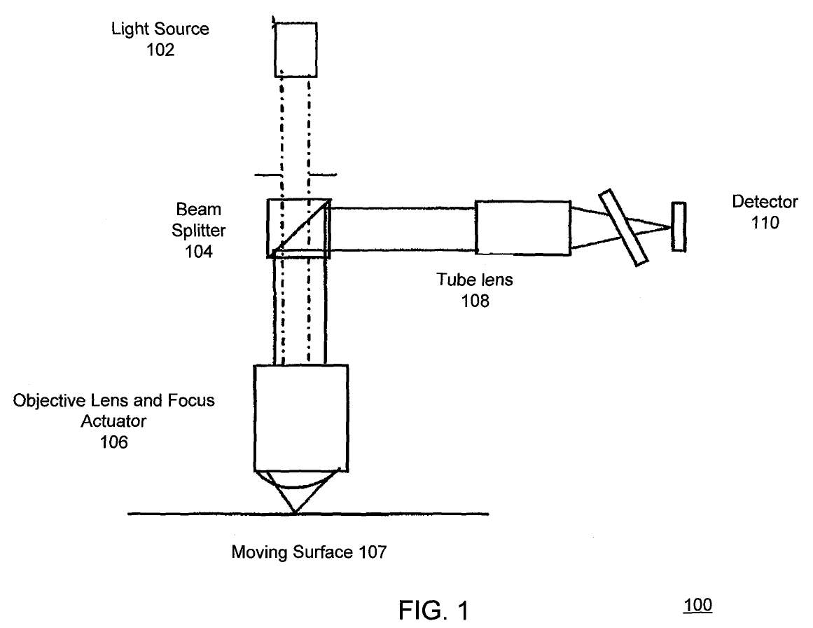

FIG. 1 is a schematic diagram showing basic components of an optical apparatus 100 which may be utilized to obtain a reflected light signal relating to surface microstructure in accordance with an embodiment of the invention. As shown, the apparatus 100 includes a light source 102, a beam splitter 104, an objective lens and force actuator 106, a sample stage 107, a tube lens 108, and a detector 110.

The light source 102 may comprise a laser. The laser beam output passes through the beam splitter 104. An auto-focus system, comprising an objective lens and a focus actuator 106, is used to maintain proper focus of the laser light onto a moving surface 107. In one embodiment, the moving surface 107 may comprise a circle at or near an outer circumference of an aluminum chuck of a rotary wafer stage.

A light signal is reflected from the moving surface 107 and is then reflected by the beam splitter 104 onto a point detector. As shown, the point detector may comprise an arrangement which includes a tube lens 108 which focuses the light signal onto a detector 110.

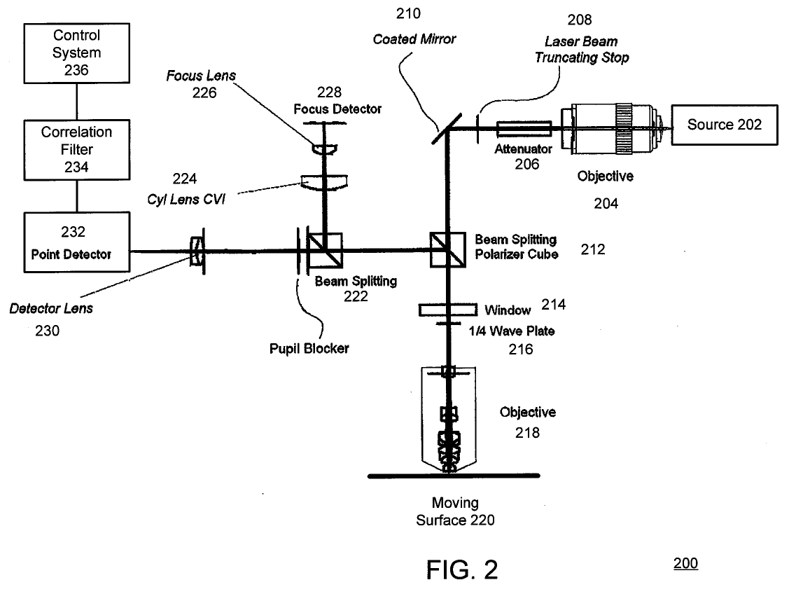

FIG. 2 is a schematic diagram of a specific implementation of an optical apparatus which may be utilized to obtain a reflected light signal relating to surface microstructure in accordance with an embodiment of the invention. As shown, the apparatus 200 includes, among other components, a light source 202, two beam splitting polarizer cubes 212 and 222, two objective lenses 204 and 218, a moving surface 220, and focus and point detectors 228 and 232.

The light source 202 may comprise a laser. For example, the laser may be a solid state laser operating at a wavelength of 640 nanometers (nm). The laser beam output may pass through a first objective lens 204, an attenuator 206, and a laser beam truncating stop (aperture) 208. The first objective lens 204 is configured to collimate the laser light and may be, for example, a 20× magnification microscope objective lens. A coated mirror 210 reflects the laser beam at an angle so that the laser beam is transmitted through a first beam splitter polarizer cube 212, a window 214, and a quarter-wave plate 216.

A second objective lens 218 (a 100× magnification objective lens, for example) is used to focus of the laser beam onto the moving surface 220. In accordance with one embodiment, the moving surface 220 may comprise an aluminum chuck of a rotary wafer stage. In particular, the laser beam may be focused on a position at a fixed radius at or near an outer radius of the metal chuck.

The laser beam is reflected from the moving surface 220 and (after returning back through the second objective lens 218, the quarter-wave plate 216, and window 214) is subsequently reflected by the first beam splitter polarizer cube 212 at an angle towards the focus and point detectors 228 and 232.

As shown, a second beam splitting polarizer cube 222 may mostly transmit the laser beam to the point detector 232 while partially reflecting the laser beam at an angle to a focus detector 228. The transmitted portion of the beam may be transmitted through a detector lens 230 to the point detector 232, and the reflected portion of the beam may be transmitted through a cylindrical lens 224 and a focus lens 226 to the focus detector 228. The point detector 232 may comprise, for example, a silicon PIN diode detector, and the focus detector 228 may comprise, for example, an astigmatic focus sensor configured to determine whether or not the light is properly focused on the moving surface.

A correlation filter 234 may be used to generate a position measurement signal from the output of the point detector 232. In one embodiment, as discussed further below, the correlation filter 234 may be previously calibrated and may apply cross-correlation with a calibrated signal to generate the position measurement signal. The position measurement signal may be fed to a control system 236 configured to control the motion of the moving surface using the position measurement signal as feedback.

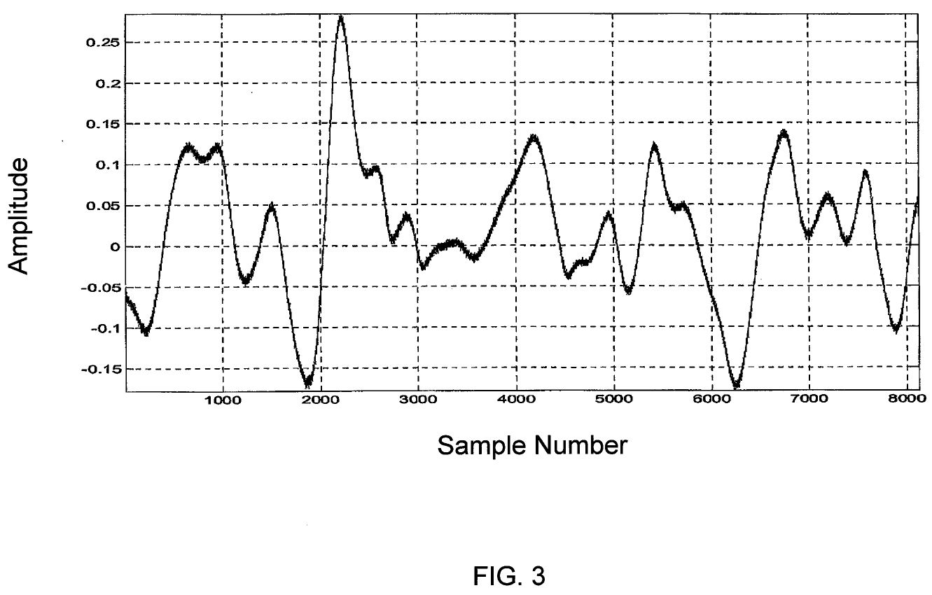

FIG. 3 is a graph showing an example reflected light signal which was obtained by focusing a laser beam onto a moving metal surface in accordance with an embodiment of the invention. The graph shows ten repetitions of scanning a 200 micron long section of the rotating aluminum chuck. The signal was digitized at a rate of about 62 samples per micrometer of motion and shows spatial frequencies higher than 300 lines per millimeter, high repeatability, and low noise.

As seen from the graph, the spatial randomness is essentially a function of spatial position and does not vary in time. Hence, applicants have determined that precise position measurement may be accomplished by first calibrating the motion of the micro-structure and then correlating the real-time signal with the calibrated signal.

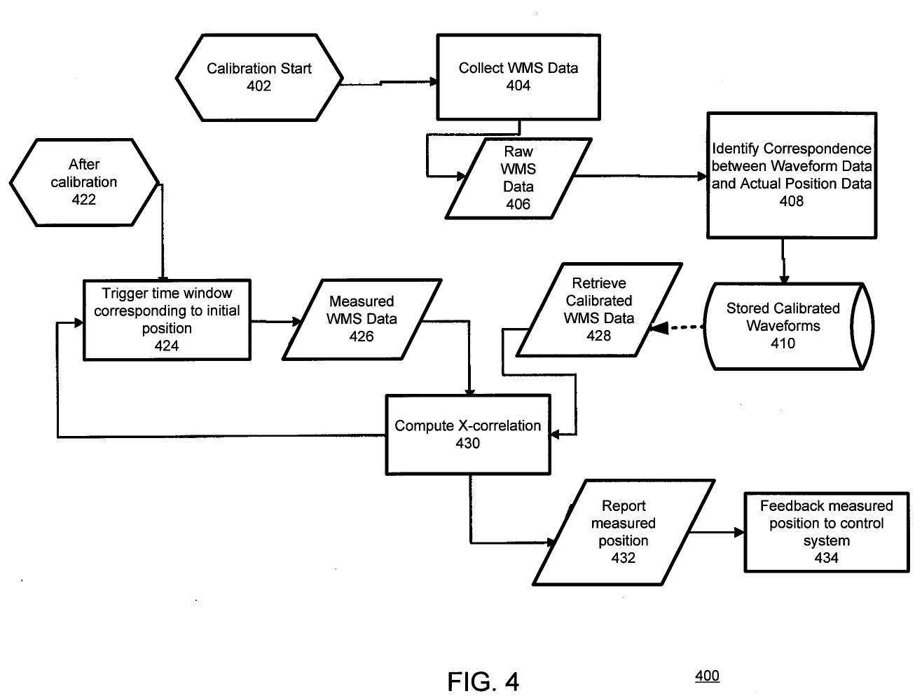

FIG. 4 is a flow chart showing a method of calibration (blocks 402 through 410) and a method of position computation (blocks 422 through 432) in accordance with an embodiment of the invention. The calibration is performed prior to the position computation, and the position computation utilizes stored wave forms which are generated by the calibration.

At the start 402 of the calibration, the wave form (WMS) data is collected 404. For example, the WMS data for a desired range of motion may be collected using the apparatus described above in relation to FIG. 1 or FIG. 2. In particular, a time window may be opened and used to encompass a range of motion of the moving surface, and the data may be collected in this time window. The resultant raw WMS data 406 may be digitized and stored in memory.

The raw WMS data 406 may then be analyzed to identify 408 a correspondence between the raw WMS data 406 and actual position data (for example, angular sector data or linear position data). In other words, corresponding actual positions on the moving surface are determined for various points in the raw WMS data 406. In one implementation, the analysis technique may be based on modeling the motion decay of a free rotating mass. (See, for example, U.S. Patent Application Publication US 2009/0030638, entitled “Self-Calibration Method and Apparatus for On-Axis Rotary Encoders,” by Xiaodong Lu.) The resultant calibrated waveforms (including the wave form data and corresponding actual position data) may be stored 410 for subsequent use in the method of position computation.

After 422 the calibration, the beginning of the time window may be triggered 424 as the moving surface past an initial position which corresponds to the beginning of the time window. The WMS data for the desired range of motion may then be measured, again using the apparatus described above in relation to FIG. 1 or FIG. 2, so as to generate the measured WMS data 426.

A cross-correlation (X-correlation) may then be computed 430 between the measured WMS data 426 and the calibrated WMS data 428 (which is retrieved from the stored calibrated waveforms 410). The cross-correlation computation 430 may determine a speed difference (if any) and a time shift (if any) in the data between the measured WMS data 426 and the calibrated WMS data 428.

The measured WMS data 426 and the calibrated WMS data 428 may be obtained using different speeds for the moving surface. If this is the case, then the calibrated WMS data 428 may be scaled (“stretched” or “shrunk”) appropriately so that it relates to the same speed for the moving surface as was used to obtain the measured WMS data 426. The scaling may be done in real-time, or it may be done during the calibration procedure. In the latter case, the calibrated WMS data for various speeds may be stored in the reference database 410 for retrieval during the measurement procedure.

In regard to the time shift, the measured WMS data 426 may be delayed (have a time delay) with respect to the calibrated WMS data 428, or the measured WMS data 426 may be advanced (have a time advance) with respect to the calibrated WMS data 428. The time shift which is determined may be used to adjust the measured WMS data 426 so that an accurate and precise measured position may be reported 432 to a control or measurement system. The time shift may be calculated to within a fraction of a sample time interval.

The measurement method may continue in a loop. In particular, the beginning of the time window may again be triggered 424 as the moving surface moves past an initial position which corresponds to the beginning of the time window.

A signal which corresponds to the reported measured position may be fed back 434 to a control system. The control system may be configured to utilize the measured position signal as feedback to control the movement or positioning of the moving surface.

Validation of the method and apparatus described herein was performed and is now described. For validation purposes, a correlation filter was created. In this case, the correlation filter created was an N-tap FIR (finite impulse response) filter where the numerator is selected to be a reference burst of data (with the most recent data as the coefficient of the highest-order term in the filter numerator polynomial).

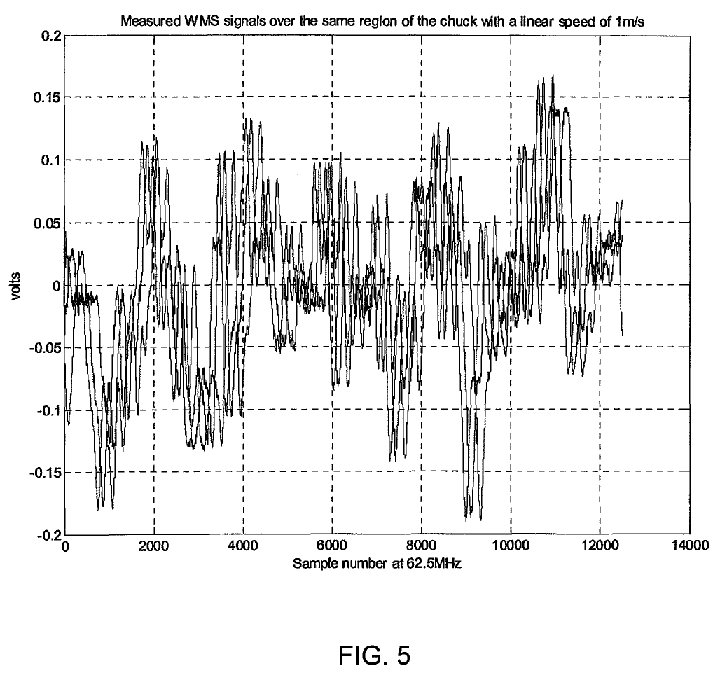

Bursts of wave form data were collected, where, in this instance, each burst has 12,500 samples. Multiple such bursts, collected from a same section of the moving surface (in this case, a same section of the rotating chuck), are shown in FIG. 5 on a scale which shows scan-to-scan jitter. The capability to measure this jitter is indicative of the measurement accuracy and precision.

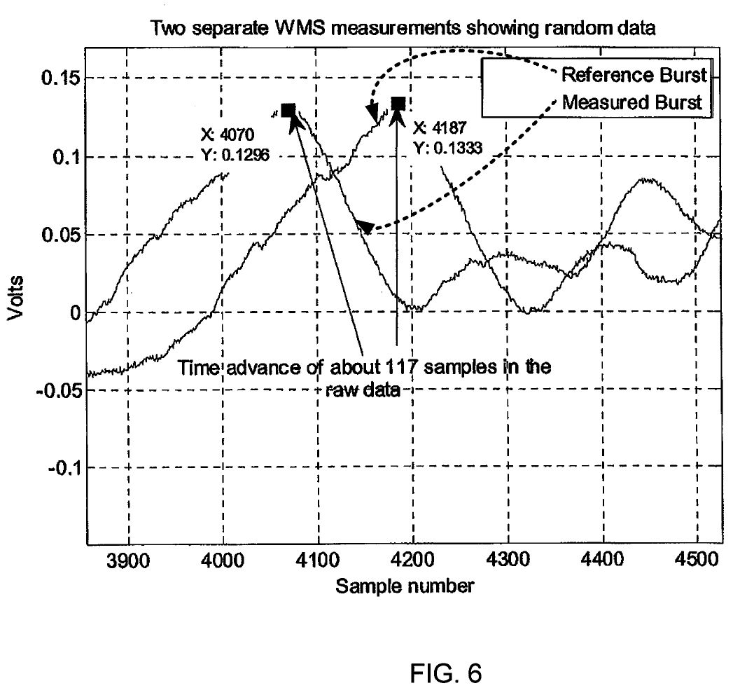

FIG. 6 provides a “zoomed in” view showing about 650 samples each of a “reference” burst of data (the reference wave form) and a “measured” burst of data (the measured wave form). If the reference and measured wave forms are aligned perfectly, then the peak in the correlation filter output should occur at a sample number of S, where S is the number of samples per wave form. Here, S is 12,500 (the number of samples per burst of data).

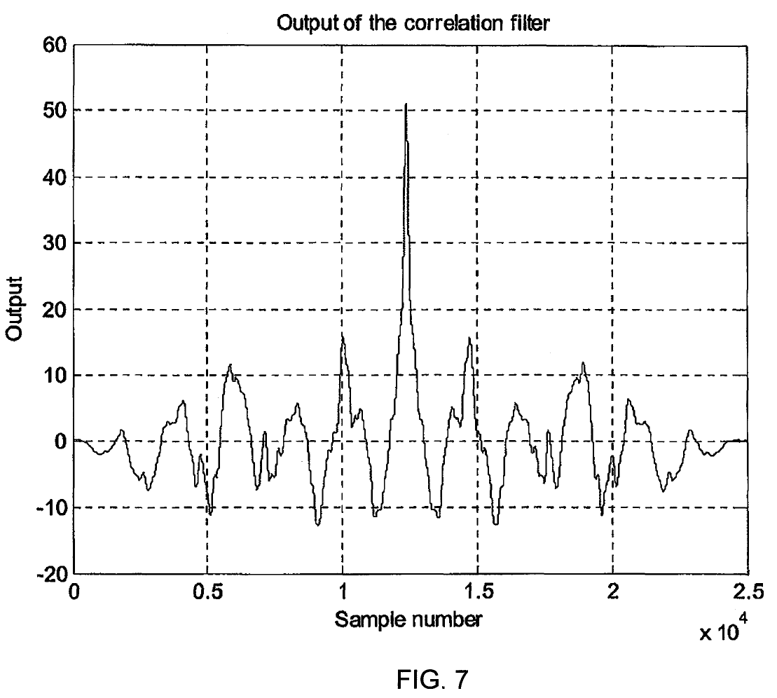

FIG. 7 shows an output of a correlation filter for the reference and measured wave forms discussed above. The peak in the output turns out to be at a sample number of 12,383. Since 12,383 is 117 less than S=12,500, this indicates that there are about 117 samples of time advance in the measured wave form relative to the reference wave form. More generally, if the peak occurred at a sample number of S−M, then a time advance of M samples would be indicated in the measured wave form relative to the reference wave form. On the other hand, if the peak occurred at a sample number of S+M, then a time delay of M samples would be indicated in the measured wave form relative to the reference wave form.

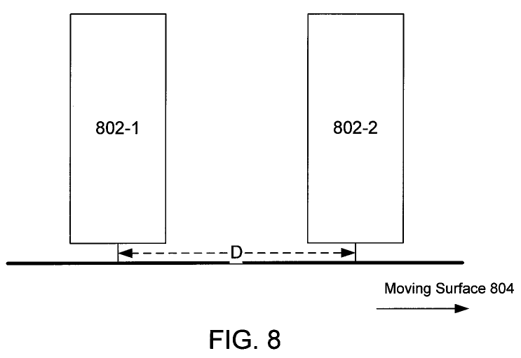

FIG. 8 shows an apparatus for measuring a speed of a moving surface using surface micro-structure in accordance with an embodiment of the invention. The apparatus includes at least two of the micro-structure movement measuring apparatus 802, such as those described above in relation to FIG. 1 or 2. In the particular example shown in FIG. 8, there are two such measuring apparatus 802-1 and 802-2. The two measuring apparatus are placed a distance D apart in the direction of surface movement whose speed is to be measured. With such a configuration, the wave form data from the two measuring apparatus 802-1 and 802-2 may be analyzed to determine a time advance which indicates the time period T which it took for a point on the surface to move from the first measuring apparatus to the second measuring apparatus (or time delay if the surface movement is in the opposite direction). The apparatus may then compute the measured speed by dividing the distance D by the time period T, and the measured speed of the moving surface may then be output (including an indication of the direction of motion, if needed).

Note that while the moving surface described above is a metal surface with micro-structure, the applicants contemplate that other embodiments may be used on other types of moving surfaces, such as ceramic or other material types, so long as the surface has micro-structure which may be tracked.

Further note that, while the above description provides details on implementing an optical apparatus for measuring a surface movement using micro-structure, the applicants contemplate that another embodiment may possibly be implemented which utilizes capacitative measurements, rather than optical measurements, of the movement of the surface microstructure.

Example Instrumentation (Reflection Electron Beam Lithography Apparatus with Rotary Wafer Stage)

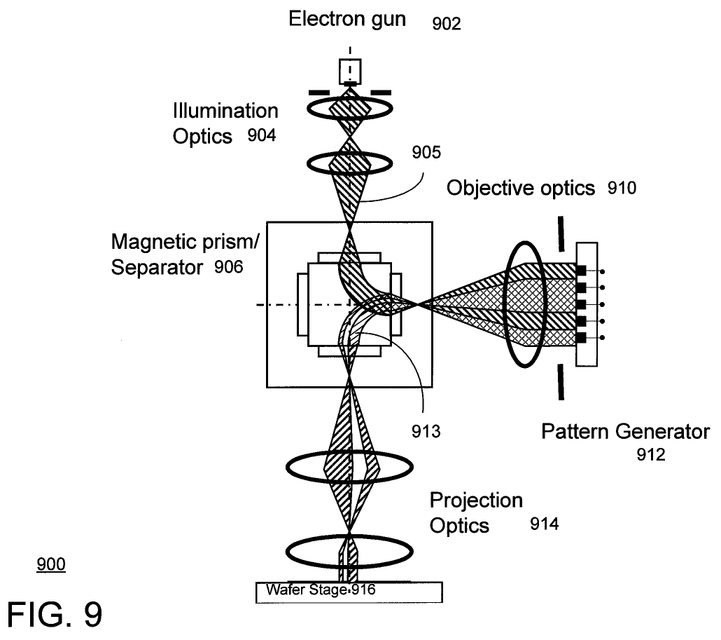

FIG. 9 is a schematic diagram of an example instrument with which an embodiment of the invention may be employed. The example instrument shown in FIG. 9 is a maskless reflection electron beam projection lithography (reflection electron beam lithography or REBL) apparatus 900. Note that other embodiments of the invention may be employed with other instruments (such as, for example, other manufacturing apparatus) or in other applications where the motion of a moving surface is to be accurately and precisely measured and/or controlled. As such, the applicants contemplate that the claimed invention will not be limited to the specific example instrumentation described in this section.

As depicted in FIG. 9, the example REBL apparatus 900 includes an electron source 902, illumination electron-optics 904, a magnetic prism 906, an objective electron lens 910, a dynamic pattern generator (DPG) 912, projection electron-optics 914, and a wafer stage 916 for holding a wafer or other targets to be lithographically patterned. The various components of the apparatus 900 may be implemented as follows.

The electron source 902 may be implemented so as to supply a large current at low brightness (current per unit area per solid angle) over a large area. The large current is to achieve a high throughput rate. One implementation uses LaB₆, a conventional electron emitter as the source material. Another implementation uses tungsten dispenser emitters as the source material. Other possible emitter implementations include a tungsten Schottky cathode, or heated refractory metal disks (i.e. Ta). The electron source 902 may be further implemented so as to have a low energy spread.

The illumination electron-optics (illumination optics, for brevity) 904 is configured to receive and collimate the electron beam from the source 902. The illumination optics 904 allows the setting of the current illuminating the pattern generator structure 912 and therefore determines the electron dose used to expose the substrate. The illumination optics 904 may comprise an arrangement of magnetic and/or electrostatic lenses configured to focus the electrons from the source 902 so as to generate an incident electron beam 905. The specific details of the arrangement of lenses depend on specific parameters of the instrument and may be determined by one of skill in the pertinent art.

The magnetic prism 906 is configured to receive the incident beam 905 from the illumination optics 904. As the incident beam traverses the magnetic fields of the prism, a force proportional to the magnetic field strength acts on the electrons in a direction perpendicular to their trajectory (i.e. perpendicular to their velocity vectors). In particular, the trajectory of the incident beam 905 is bent towards the objective lens 910 and the dynamic pattern generator 912.

Below the magnetic prism 906, the electron-optical components of the objective optics are common to the illumination and projection subsystems. The objective optics may be configured to include the objective lens 910 and one or more transfer lenses (not shown). The objective optics receives the incident beam from the prism 906 and decelerates and focuses the incident electrons as they approach the DPG 912. The objective optics is preferably configured (in cooperation with the gun 902, illumination optics 904, and prism 906) as an immersion cathode lens and is utilized to deliver an effectively uniform current density (i.e. a relatively homogeneous flood beam) over a large area in a plane above the surface of the DPG 912.

The dynamic pattern generator 912 comprises an array of pixels. Each pixel may comprise a metal contact to which a voltage level is controllably applied. The extraction part of the objective lens 910 provides an extraction field in front of the DPG 912. As the reflected electrons 913 leave the DPG 912, the objective optics is configured to accelerate the reflected electrons 913 toward their second pass through the prism 906. The prism 906 is configured to receive the reflected electrons 913 from the transfer lens 908 and to bend the trajectories of the reflected electrons towards the projection optics 914.

The projection electron-optics (projection optics) 914 reside between the prism 906 and the wafer stage 916. The projection optics 914 is configured to focus the electron beam and demagnify the beam onto photoresist on a wafer or onto another target. The demagnification may range, for example, from 1× to 100× demagnification (i.e. 1× to 0.01× magnification). In accordance with an embodiment of the invention, the wafer stage 916 may comprise a vacuum chuck that holds a target semiconductor wafer and is configured to be in a rotational or spiral motion during the lithographic projection.

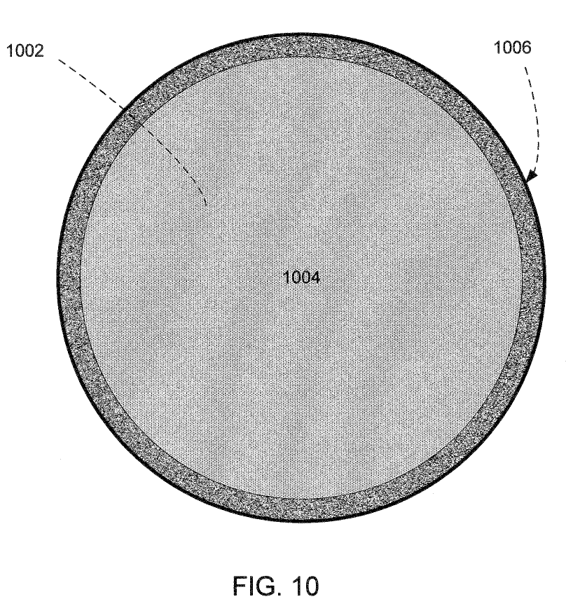

FIG. 10 is a top view diagram of a rotatable chuck 1002 configured to hold a semiconductor wafer in accordance with an embodiment of the invention. As shown, the rotatable chuck 1002 has a center circular 1004 which is configured to hold a semiconductor wafer. The wafer may be held against the chuck by a vacuum force, for example. In accordance with an embodiment of the invention, it is desirable to measure the rotating motion at or near an outer circumference 1006 of the chuck 1002 so as to accurately and precisely control the rotation of the chuck 1002.

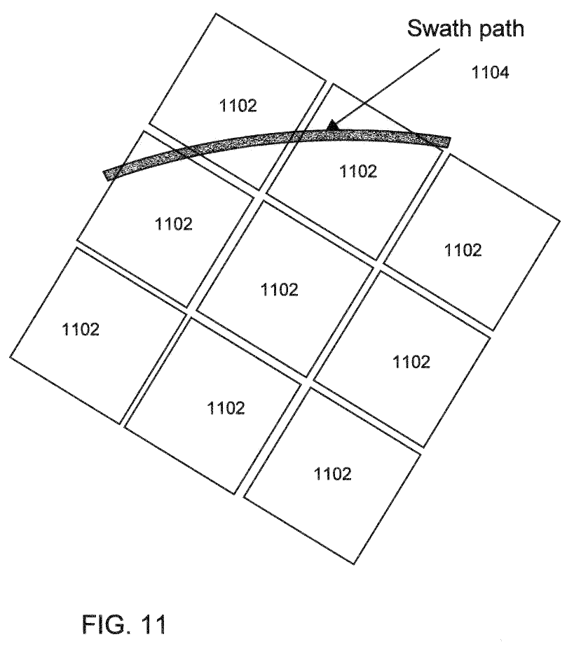

FIG. 11 is a top view diagram showing a swath path 1104 arcing across an array of die areas 1102 on a semiconductor wafer in accordance with an embodiment of the invention. The swath path 1104 is the path area covered by the projected beam as the semiconductor wafer rotates. In other words, it is the path area which is patterned during one pass as the wafer rotates under the projected beam.

Note that the above description describes in detail an embodiment of the invention which utilizes an optical microscope apparatus for measuring a signal which varies with changes in surface micro-structure of a moving surface. However, other measuring apparatus may be used in alternate embodiments of the invention.

In one alternate embodiment, the measuring apparatus includes a detector which is configured to detect a capacitative signal which varies based on the surface microstructure of the moving surface. In this embodiment, changes in capacitance are measured to generate the wave form data.

In another alternate embodiment, the measuring apparatus includes a detector which is configured to detect an inductive signal which varies based on the surface microstructure of the moving surface. In this embodiment, changes in inductance are measured to generate the wave form data.

More generally, the measuring apparatus includes a detector which is configured to detect a measurable signal which varies in a repeatable and reliable manner based on the surface microstructure of the moving surface. In this embodiment, changes in the signal are determined to generate the wave form data.

In this application, we have disclosed a novel and inventive metrology approach that overcomes limitations in the precision and accuracy of conventional optical encoders. The technique disclosed herein relies on the sensing of a signal obtained from surface micro-irregularities as the surface is scanned by an optical microscope instrument. Disclosed herein are the principles of operation, the construction of a suitable scanning microscope and data acquisition system, and computations that may be used for calibrating the measurement database and for high-bandwidth motion tracking. Also disclosed are measurement data that demonstrates that motion control with sub-micron or nanometer-level precision and accuracy is obtainable with this metrology approach. The technique disclosed herein is applicable for either angular or linear position measurement and control.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An apparatus for measuring position and/or motion using surface micro-structure of a moving surface, the apparatus comprising:
a detector configured to generate an output signal which varies in correspondence with the surface micro-structure; and
a correlation filter configured to receive the output signal, apply cross-correlation between the output signal and a calibrated signal, and generate a measured position signal.

2. The apparatus of claim 1, further comprising:
a source of coherent light; and
an objective lens configured to focus the light on the moving surface, wherein the light is reflected from the moving surface to form a reflected light signal, and the moving surface has surface micro-structure,
wherein the detector is configured to detect said reflected light signal.

3. The apparatus of claim 1, wherein the detector is further configured to detect a capacitative signal which varies based on the surface microstructure of the moving surface.

4. The apparatus of claim 1, wherein the detector is further configured to detect an inductive signal which varies based on the surface microstructure of the moving surface.

5. The apparatus of claim 1, wherein the surface is moving continuously.

6. The apparatus of claim 1, further comprising:
data storage configured to store the calibrated signal for use by the cross-correlation filter.

7. The apparatus of claim 1, further comprising:
a control system configured to receive the measured position signal as feedback for control of the moving surface.

8. The apparatus of claim 2, further comprising:
a quarter-wave plate; and
a beam splitter configured to transmit the light from the source to the objective lens and reflect the light from the moving surface to the detector, wherein the quarter-wave plate is positioned between the beam splitter and the objective lens.

9. The apparatus of claim 2, further comprising:
a second detector comprising a focus detector configured to determine whether the light is focused on the moving surface.

10. The apparatus of claim 1, wherein the output signal varies in correspondence with sub-micron variations in the surface micro-structure.

11. The apparatus of claim 1, wherein the moving surface comprises a metal surface.

12. The apparatus of claim 1, wherein the moving surface is moving rotationally.

13. A method comprising:
using a measuring apparatus to collect a first set of wave form data from a moving surface, wherein the first set of wave form data depends on micro-structure of the moving surface;
identifying a correspondence between the first set of wave form data and actual position data using a computing device; and
storing, in a tangible data storage medium, calibrated wave form data indicating said correspondence between the first set of wave form data and actual position data.

14. The method of claim 13, wherein the measuring apparatus comprises an optical microscope apparatus and measures changes in reflected light to generate the wave form data.

15. The method of claim 13, wherein the measuring apparatus measures changes in capacitance to generate the wave form data.

16. The method of claim 13, wherein the measuring apparatus measures changes in inductance to generate the wave form data.

17. The method of claim 13, further comprising:
using the measuring apparatus to collect a second set of wave form data from a moving surface, wherein the second set of wave form data depends on micro-structure of the moving surface; and
computing a cross-correlation between the second set of wave form data and the calibrated wave form data.

18. The method of claim 17, further comprising:
generating a measured position signal based on the second set of wave form data and a time difference indicated by the computed cross-correlation.

19. The method of claim 18, further comprising:
providing the measured position signal as a feedback signal to a control system configured to control the moving surface.

20. The method of claim 13, wherein said wave form data varies in correspondence with sub-micron variations in the surface micro-structure.

21. The method of claim 13, wherein the moving surface comprises a metal surface.

22. The method of claim 13, wherein the moving surface is moving rotationally.

23. A method for measuring motion using surface micro-structure, the method comprising:
using a first apparatus to collect a first wave form from a moving surface, wherein the first wave form depends on micro-structure of the moving surface;
using a second apparatus to collect a second wave form from a moving surface, wherein the second wave form depends on micro-structure of the moving surface, and the second apparatus is separated from the first apparatus by a fixed distance;
determining a time advance which indicates a time period during which a point on the moving surface moved between the first apparatus and the second apparatus; and
computing a speed of the moving surface based on dividing the fixed distance by the time period.

24. The method of claim 23, further comprising:
computing a cross-correlation between said wave forms in order to determine the time advance.

25. The method of claim 23, wherein said wave forms vary in correspondence with sub-micron variations in the surface micro-structure.
